(19) United States
(12) Patent Application Publication
(10) Pub. No.: US 2017/0198592 A1
(43) Pub. Date: Jul. 13, 2017

(54) METHODS FOR MOUNTING A TURBINE SUBCOMPONENT TO A TURBINE COMPONENT

(71) Applicant: GENERAL ELECTRIC COMPANY, Schenectady, NY (US)

(72) Inventors: Andrew Joseph Colletti, Greenville, SC (US); Bryan Edward Williams, Greenville, SC (US); Charles Van Buchan, Greer, SC (US)

(21) Appl. No.: 14/992,091

(22) Filed: Jan. 11, 2016

(51) Int. Cl. F01D 5/30; B23P 15/04

(52) U.S. Cl. CPC F01D 5/3061; F01D 5/3007; B23P 15/04; F05D 2220/32; F05D 2230/232; F05D 2230/10

(57) ABSTRACT

Methods for mounting a turbine subcomponent to a turbine component are disclosed, including positioning a retaining portion of the turbine subcomponent along a positioning path into association with an emplacement of the turbine component. The retaining portion is orthogonally interlocked with the emplacement relative to the positioning path. The retaining portion and the emplacement define at least one interface extending along the positioning path. The retaining portion is welded to the emplacement along the at least one interface, forming at least one weld.

### FIELD OF THE INVENTION

The present invention is directed to methods for mounting a turbine subcomponent to a turbine component. More particularly, the present invention is directed to methods for mounting a turbine subcomponent to a turbine component by welding.

### BACKGROUND OF THE INVENTION

Gas turbines operate under extreme conditions, including elevated temperatures, corrosive environments, and high speed rotational contact between turbine components. These conditions cause wear over time on certain of the turbine components, necessitating repair or partial or complete replacement of the components. Therefore certain components, such as airfoils, are reversibly attached to facilitate inspection, repair and replacement. Additionally, other components include rotational wear surfaces which degrade over time and which therefore must be removed and repaired or replaced, for example, with patch rings.

Installation of components such as airfoils and patch rings typically includes attachment by techniques such as staking, in order to securely attach the component under the rigorous operating conditions of gas turbines. However, attachment by staking may include certain disadvantages, such as crack susceptibility, lack of repeatability, and imprecision. Further, in some cases, automation of the staking process may be impractical.

### BRIEF DESCRIPTION OF THE INVENTION

In an exemplary embodiment, a method for mounting a turbine subcomponent to a turbine component includes positioning a retaining portion of the turbine subcomponent along a positioning path into association with an emplacement of the turbine component. The retaining portion is orthogonally interlocked with the emplacement relative to the positioning path. The retaining portion and the emplacement define at least one interface extending along the positioning path. The retaining portion is welded to the emplacement along the at least one interface, forming at least one weld.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is a perspective view of a turbine subcomponent in position to be mounted to a turbine component, according to an embodiment of the present disclosure.

FIG. 2 is a perspective view of the turbine subcomponent of FIG. 1 while being mounted to the turbine component of FIG. 1, according to an embodiment of the present disclosure.

FIG. 3 is a perspective view of the turbine subcomponent of FIG. 1 with the retaining portion fully engaged into the emplacement of the turbine component of FIG. 1, according to an embodiment of the present disclosure.

FIG. 4 is a plan view of the turbine subcomponent of FIG. 1 mounted to the turbine component of FIG. 1, according to an embodiment of the present disclosure.

FIG. 5 is a front view of the turbine subcomponent of FIG. 1 mounted to the turbine component of FIG. 1, according to an embodiment of the present disclosure.

FIG. 6 is a perspective view of a turbine subcomponent in position to be mounted onto a turbine component, according to an embodiment of the present disclosure.

FIG. 7 is a perspective view of the turbine subcomponent of FIG. 6 mounted onto the turbine component of FIG. 6, according to an embodiment of the present disclosure.

FIG. 8 is a perspective view of a turbine subcomponent in position to be mounted into a turbine component, according to an embodiment of the present disclosure.

FIG. 9 is a perspective view of the turbine subcomponent of FIG. 8 mounted into the turbine component of FIG. 8, according to an embodiment of the present disclosure.

Wherever possible, the same reference numbers will be used throughout the drawings to represent the same parts.

### DETAILED DESCRIPTION OF THE INVENTION

Provided are exemplary methods for mounting a turbine subcomponent to a turbine component. Embodiments of the present disclosure, in comparison to methods not utilizing one or more features disclosed herein, decrease costs, increase reparability, improve component engagement, reduce life cycle costs, increase service intervals, improve retention properties, reduce the weld heat affected zone, reduce susceptibility of airfoil walking, reduce susceptibility of crack formation, or a combination thereof.

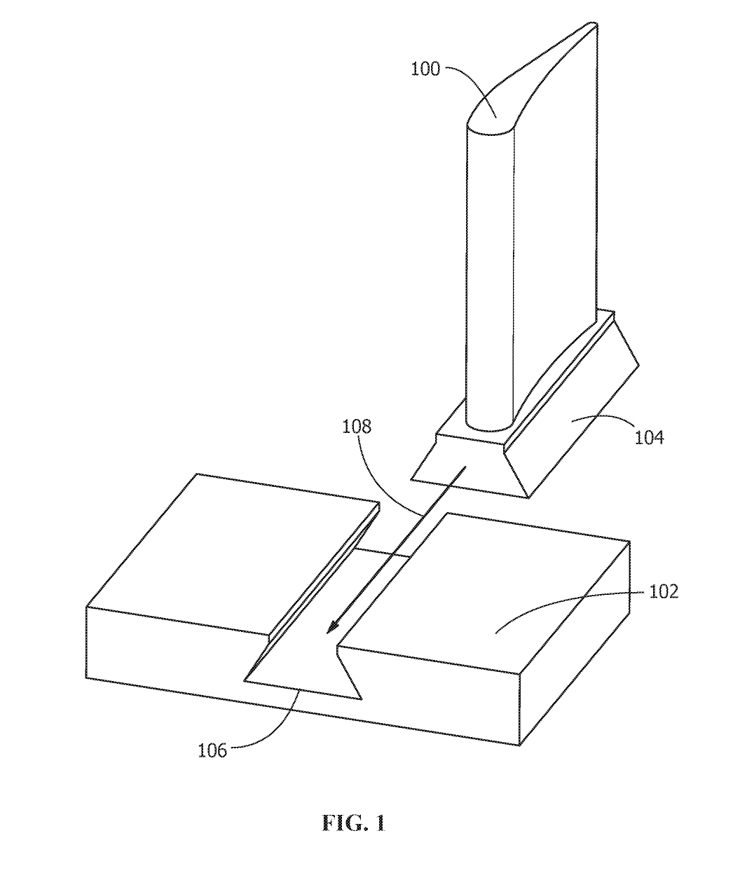

Referring to FIG. 1, in one embodiment, a turbine subcomponent 100 is mounted to a turbine component 102. The turbine subcomponent 100 includes a retaining portion 104. The turbine component 102 includes an emplacement 106. The turbine component 102 may be any suitable component, including, but not limited to, a wheel (disk). The turbine subcomponent 100 may be any component suitable for mounting to the turbine component 102, including, but not limited to, at least one of an airfoil having a dovetail as the retaining portion 104, a bushing, a patch ring, a journal sleeve, an instrumentation plug, and a coverplate.

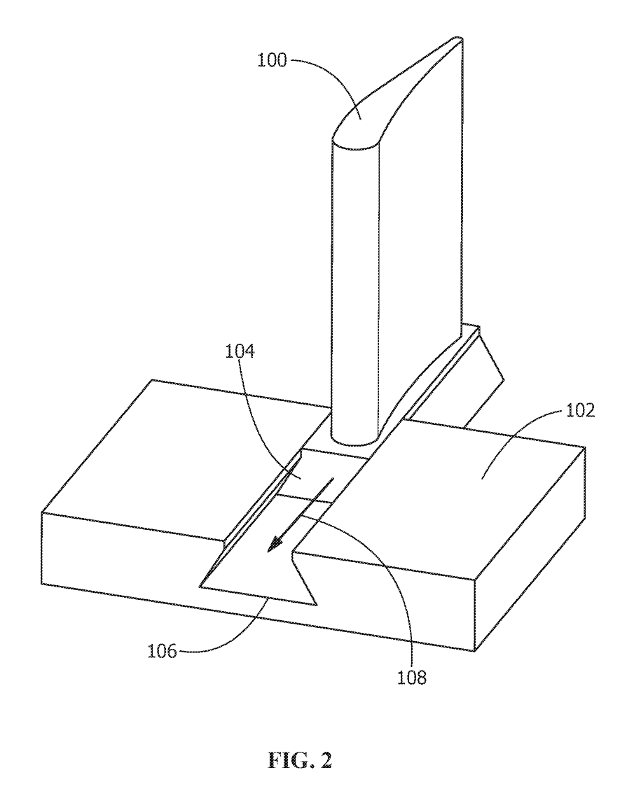

Referring to FIGS. 1-3, in one embodiment, the retaining portion 104 is positioned along a positioning path 108 into association with an emplacement 106.

Referring to FIG. 3, the retaining portion 104 is orthogonally interlocked with the emplacement 106 relative to the positioning path 108. The retaining portion 104 and the emplacement 106 define at least one interface 200 extending along the positioning path 108. The at least one interface 200 may include a first interface 300 and a second interface 302.

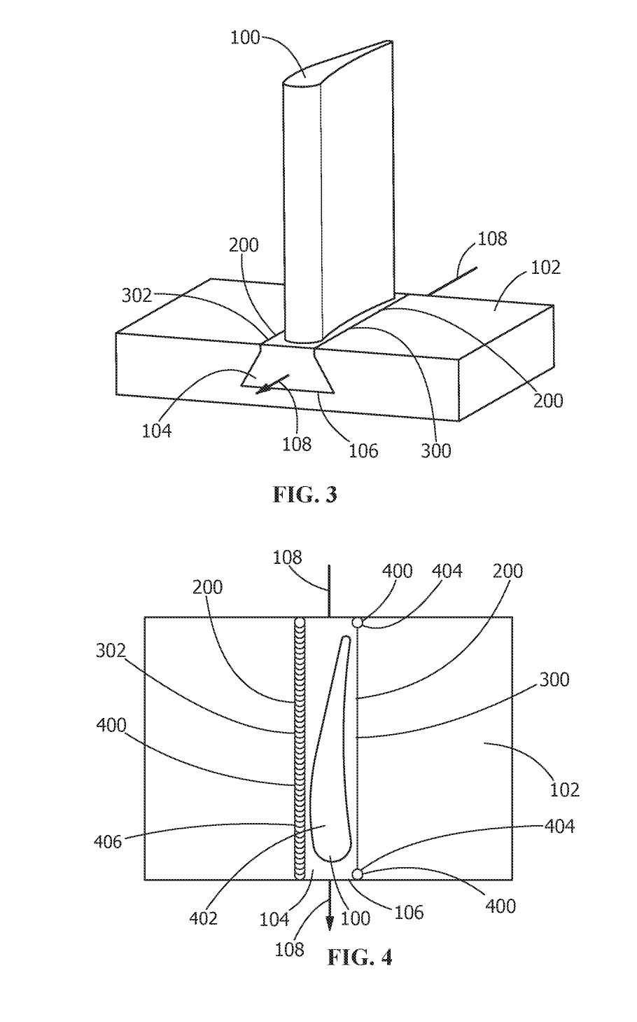

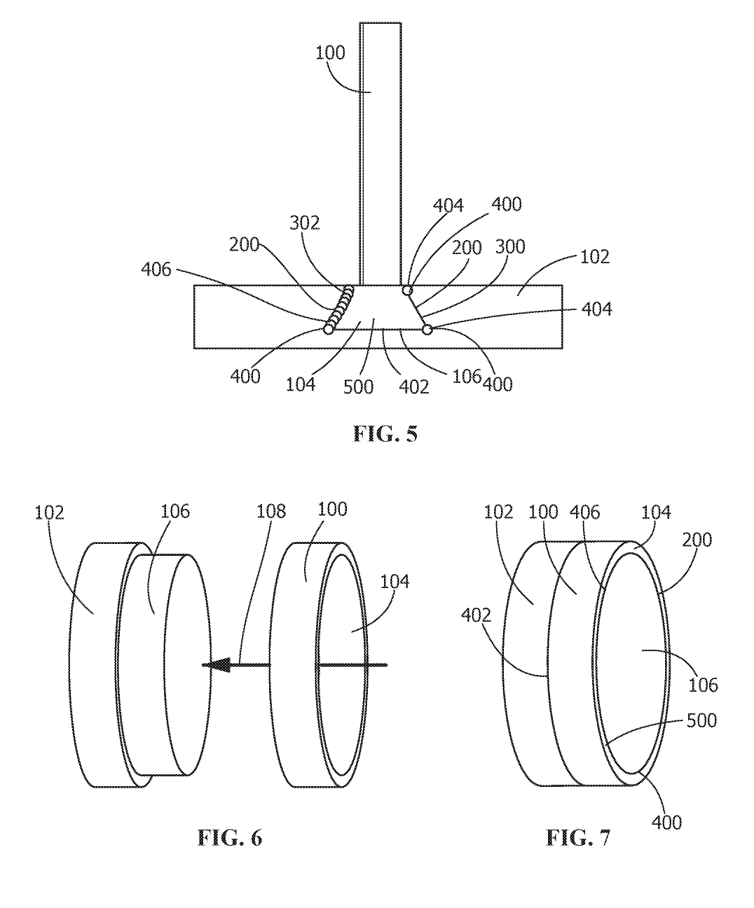

Referring to FIGS. 4 and 5, in one embodiment, the retaining portion 104 is welded to the emplacement 106 along the at least one interface 200, forming at least one weld 400. Welding the retaining portion 104 to the emplacement 106 along the at least one interface 200 may include any suitable welding technique. In one embodiment, the suitable welding techniques is a friction welding technique, such as, but not limited to, friction stir welding, friction spot welding, or a combination thereof. In another embodiment, the welding technique includes, in addition to or in lieu of a friction welding technique, at least one of gas tungsten arc welding, gas metal arc welding, shielded metal arc welding, flux-cored arc welding, electroslag welding, submerged arc welding, plasma arc welding, laser beam welding, electron beam welding, resistance welding, or a combination thereof. Suitable welding techniques may produce a weld penetration depth of less than about 0.25 inches, alternatively less than about 0.15 inches, alternatively less than about 0.1 inches, alternatively between about 0.02 inches and about 0.25 inches, alternatively between about 0.02 inches and about 0.15 inches, alternatively between about 0.02 inches and about 0.1 inches, alternatively between about 0.05 inches and about 0.25 inches, alternatively between about 0.05 inches and about 0.15 inches, alternatively between about 0.05 inches and about 0.1 inches. Without being bound by theory, it is believed that a weld penetration depth which is too small may lead to insufficient weld strength for turbine operating conditions, whereas a weld penetration depth which is too large may lead to damaging the turbine subcomponent 100 or the turbine component 102 in the event that the turbine subcomponent 100 is dismounted from the turbine component 102.

Mounting the turbine subcomponent 100 to the turbine component 102 may define an independent interface 402 adjacent to the at least one interface 200 along an entire length of the at least one interface 200, wherein the retaining portion 104 remains unattached to the emplacement 106 across the independent interface 402 as the retaining portion 104 is welded to the emplacement 106. The retaining portion 104 may contact the emplacement 106 across the independent interface 402 or the retaining portion 104 may be separated from the emplacement 106 across the independent interface 402 by a gap.

In one embodiment, welding the retaining portion 104 to the emplacement 106 includes manually performing the welding. In another embodiment, welding the retaining portion 104 to the emplacement 106 includes employing an automated welding apparatus (not shown) to perform the welding. The automated welding apparatus may index along the at least one interface 200, forming the at least one weld 400.

Referring to FIG. 4, the retaining portion 104 may be welded to the emplacement 106 along the at least one interface 200 along the positioning path 108. Referring to FIG. 5, the retaining portion 104 may be welded to the emplacement 106 along the at least one interface 200 at a terminus 500 of the retaining portion 104.

Referring again to FIGS. 4 and 5, forming the at least one weld 400 may include forming a plurality of discrete welds 404 along the at least one interface 200, forming a weld seam 406 along the entire length of the at least one interface 200, or a combination thereof.

In one embodiment, wherein the at least one interface 200 includes a first interface 300 and a second interface 302, welding the retaining portion 104 to the emplacement 106 includes welding the emplacement 106 to the receptacle 104 along one of the first interface 300 and the second interface 302 or each of the first interface 300 and the second interface 302.

In one embodiment, following formation of the at least one weld 400, the turbine subcomponent 100 is dismounted from the turbine component 102. Dismounting the turbine subcomponent 100 from the turbine component 102 may include severing the at least one weld 400. Severing the at least one weld may include any suitable technique, including, but not limited to, milling the at least one weld 400, machining out the at least one weld 400, laser cutting the at least one weld 400, drilling out the at least one weld 400, chiseling out the at least one weld 400, and combinations thereof. In a further embodiment, following the dismounting of the turbine subcomponent 100 from the turbine component 102, the turbine subcomponent 100 is remounted to the turbine component 102. Between the turbine subcomponent 100 being dismounted from the turbine component 102 and remounted to the turbine component 102, the turbine subcomponent 100 may be subjected to an additional process, including, but not limited to, inspecting the turbine component 102, repairing the turbine component 102, modifying the turbine component 102, or a combination thereof. In an alternate further embodiment, following the dismounting of the turbine subcomponent 100 from the turbine component 102, a replacement turbine subcomponent (not shown) is mounted to the turbine component 102. Mounting the replacement turbine subcomponent includes positioning a replacement retaining portion (not shown) of the replacement turbine subcomponent into association with the emplacement 106.

Referring to FIGS. 6 and 7, in one embodiment positioning the retaining portion 104 into association with the emplacement 106 includes fitting the retaining portion 104 onto the emplacement 106. The retaining portion 104 is welded to the emplacement 106 along the at least one interface 200, forming the at least one weld 400. Mounting the turbine subcomponent 100 to the turbine component 102 may define the independent interface 402, wherein the retaining portion 104 remains unattached to the emplacement 106 across the independent interface 402 as the retaining portion 104 is welded to the emplacement 106. The retaining portion 104 may be welded to the emplacement 106 along the at least one interface 200 at a terminus 500 of the retaining portion 104. Forming the at least one weld 400 may include forming a plurality of discrete welds 404 (not shown) along the at least one interface 200, forming a weld seam 406 along the entire length of the at least one interface 200, or a combination thereof.

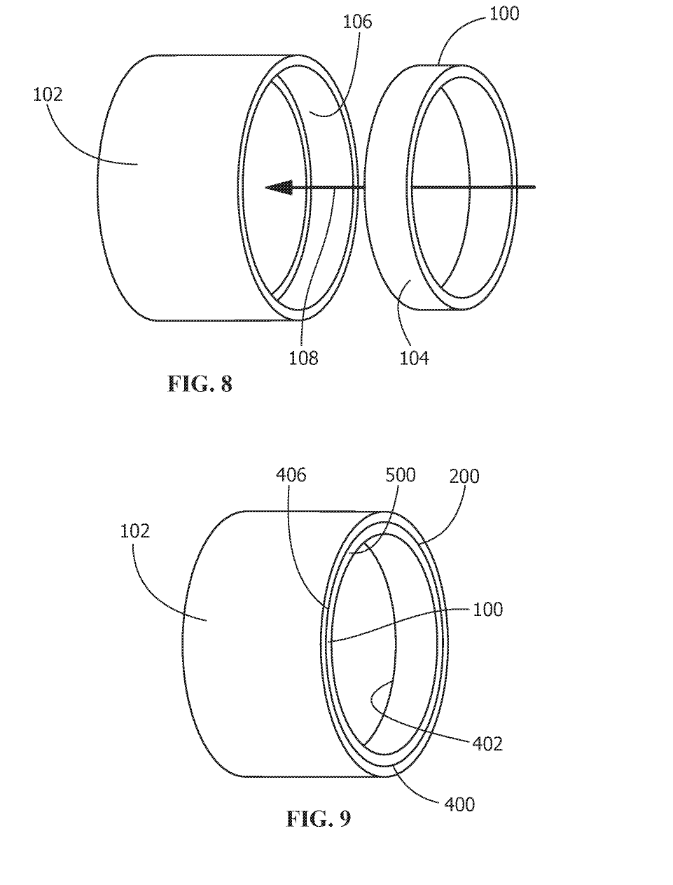

Referring to FIGS. 8 and 9, in one embodiment positioning the retaining portion 104 into association with the emplacement 106 includes fitting the retaining portion 104 into the emplacement 106. The retaining portion 104 is welded to the emplacement 106 along the at least one interface 200, forming the at least one weld 400. Mounting the turbine subcomponent 100 to the turbine component 102 may define the independent interface 402, wherein the retaining portion 104 remains unattached to the emplacement 106 across the independent interface 402 as the retaining portion 104 is welded to the emplacement 106. The retaining portion 104 may be welded to the emplacement 106 along the at least one interface 200 at a terminus 500 of the retaining portion 104. Forming the at least one weld 400 may include forming a plurality of discrete welds 404 (not shown) along the at least one interface 200, forming a weld seam 406 along the entire length of the at least one interface 200, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for mounting a turbine subcomponent to a turbine component, comprising:
positioning a retaining portion of the turbine subcomponent along a positioning path into association with an emplacement of the turbine component;
orthogonally interlocking the retaining portion with the emplacement relative to the positioning path, the retaining portion and the emplacement defining at least one interface, the at least one interface extending along the positioning path; and
welding the retaining portion to the emplacement along the at least one interface, forming at least one weld.

2. The method of claim 1, wherein positioning the retaining portion into association with the emplacement includes fitting the retaining portion into the emplacement.

3. The method of claim 1, wherein positioning the retaining portion into association with the emplacement includes fitting the retaining portion onto the emplacement.

4. The method of claim 1, wherein welding the retaining portion to the emplacement includes friction welding the retaining portion to the emplacement.

5. The method of claim 4, wherein friction welding the retaining portion to the emplacement includes friction stir welding the retaining portion to the emplacement, friction spot welding the retaining portion to the emplacement, or a combination thereof.

6. The method of claim 1, wherein forming the at least one weld includes forming a plurality of discrete welds along the at least one interface.

7. The method of claim 1, wherein forming the at least one weld includes forming a weld seam along an entire length of the at least one interface.

8. The method of claim 1, wherein defining the at least one interface includes defining a first interface and a second interface.

9. The method of claim 8, wherein welding the retaining portion to the emplacement includes welding the emplacement to the receptacle along each of the first interface and the second interface.

10. The method of claim 8, wherein forming the at least one weld includes forming a plurality of discrete welds along one of the first interface and the second interface.

11. The method of claim 1, further including dismounting the turbine subcomponent from the turbine component.

12. The method of claim 11, wherein dismounting the turbine subcomponent from the turbine component includes severing the at least one weld.

13. The method of claim 12, wherein severing the at least one weld includes a technique selected from the group consisting of milling the at least one weld, machining out the at least one weld, laser cutting the at least one weld, drilling out the at least one weld, chiseling out the at least one weld, and combinations thereof.

14. The method of claim 12, further including remounting the turbine subcomponent to the turbine component.

15. The method of claim 12, further including mounting a replacement turbine subcomponent to the turbine component, mounting the replacement turbine subcomponent including positioning a replacement retaining portion of the replacement turbine subcomponent into association with the emplacement.

16. The method of claim 1, wherein mounting the turbine subcomponent to the turbine component defines an independent interface adjacent to the at least one interface along an entire length of the at least one interface, the retaining portion remaining unattached to the emplacement across the independent interface as the retaining portion is welded to the emplacement.

17. The method of claim 1, wherein the turbine component is a wheel (disk).

18. The method of claim 17, wherein the turbine subcomponent is selected from the group consisting of at least one of a bushing, a patch ring, a journal sleeve, an instrumentation plug, and a coverplate.

19. The method of claim 17, wherein the turbine subcomponent is an airfoil and the retaining portion is a dovetail.

20. The method of claim 1, wherein welding the retaining portion to the emplacement includes an automated welding apparatus indexing along the at least one interface, forming the at least one weld.
